(19) United States
(12) Patent Application Publication
(10) Pub. No.: US 2011/0261174 A1
(43) Pub. Date: Oct. 27, 2011

(54) STEREOSCOPIC DIGITAL PROJECTION APPARATUS USING POLARIZED LIGHT

(76) Inventors: Barry D. Silverstein, Rochester, NY (US); Gary E. Nothhard, Hilton, NY (US)

(21) Appl. No.: 12/767,876

(22) Filed: Apr. 27, 2010

(51) Int. Cl. H04N 13/04; G03B 21/14

(52) U.S. Cl. 348/58; 353/8; 348/E13.026

(57) ABSTRACT

A digital projection apparatus for projecting digital image data comprising: one or more image forming assemblies; a display surface; and projection optics for projecting an image of the spatial light modulators in the one or more image forming assemblies onto the display surface. Each of the image forming assemblies includes a light source that alternately provides polarized light having a first and second orthogonal polarization axes, an integrator bar having a substantially rectangular cross section, illumination optics that direct the light from the light source onto the integrator bar; a spatial light modulator including an array of tiltable micro-mirror reflectors, each micro-mirror reflector being actuable to tilt with respect to a tilt axis responsive to the digital image data, and imaging optics for forming an image of the exit face of the integrator bar onto the spatial light modulator

### CROSS REFERENCE TO RELATED APPLICATIONS

The present invention is related to commonly assigned, co-pending U.S. Patent Publication No. 2009/0141242, entitled “Stereo projection apparatus using polarized solid state light sources” filed Nov. 30, 2007 by Silverstein et al. (attorney docket 94354); to commonly assigned, co-pending U.S. patent application Ser. No. 12/259,326, entitled “Polarization maintaining optical integration,” filed Oct. 28, 2008 by Nothhard et al. (attorney docket 95319); to commonly assigned, co-pending U.S. patent application Ser. No. 12/498,396, entitled “Etendue Reduced Stereo Projection Using Segmented Disk” filed Jul. 7, 2009 by Silverstein et al. (attorney docket 95605); to commonly assigned, co-pending U.S. patent application Ser. No. 12/488,661, entitled “Optical interference reducing element for laser projection” filed Jun. 22, 2009 by Silverstein et al. (attorney docket 95597); and to commonly assigned, co-pending U.S. patent application Ser. No. 12/502,426, entitled “Stereoscopic projector with rotating segmented disk” filed Jul. 14, 2009 by Silverstein et al. (attorney docket 95604), each of which, is incorporated herein by reference.

### FIELD OF THE INVENTION

This invention generally relates to an apparatus for projecting a stereoscopic digital image, and more particularly relates to an improved apparatus and method using polarized solid state lasers to create stereoscopic images for digital cinema projection.

### BACKGROUND OF THE INVENTION

In order to be considered as suitable replacements for conventional film projectors, digital projection systems must meet demanding requirements for image quality. This is particularly true for multicolor cinematic projection systems. Competitive digital projection alternatives to conventional cinematic-quality projectors must meet high standards of performance, providing high resolution, wide color gamut, high brightness, and frame-sequential contrast ratios exceeding 1,000:1.

Increasingly, the motion picture industry has moved toward the production and display of 3-dimensional (3D) or perceived stereoscopic content in order to offer consumers an enhanced visual experience in large venues. While entertainment companies such as Disney have offered this content in their theme parks for many years and Imax has created specialty theatres for such content, in both those cases film has been the primary medium for image creation. One common method to create stereoscopic images is to use two projectors to simultaneously project a pair of images using orthogonal polarizations, one image for each eye. Audience members wear corresponding orthogonally polarized glasses that block one polarized light image for each eye while transmitting the orthogonal polarized light image.

In the ongoing transition of the motion picture industry to digital imaging, some vendors, such as Imax, have continued to utilize a two-projection system to provide a high quality stereo image. More commonly, however, conventional projectors have been modified to enable 3D projection.

Most digital cinema projection system employ, as image forming devices, one of two basic types of spatial light modulators (SLMs). The first type of spatial light modulator is the Digital Light Processor (DLP), a digital micro-mirror device (DMD), developed by Texas Instruments, Inc. of Dallas, Tex. DLP-based projectors have demonstrated the capability to provide the necessary light throughput, contrast ratio, and color gamut for most projection applications from desktop to large cinema.

The second type of spatial light modulator used for digital projection is the LCD (Liquid Crystal Device). The LCD forms an image as an array of pixels by selectively modulating the polarization state of incident light for each corresponding pixel. LCDs appear to have advantages as spatial light modulators for high-quality digital cinema projection systems. LCOS (Liquid Crystal On Silicon) devices are thought to be particularly promising for large-scale image projection.

As with conventional film-based stereoscopic projection systems, the most common methods for forming stereoscopic images using digital micro-display (DLP or LCOS) based projectors utilize polarized light having two orthogonal polarizations states. In some configurations light having two orthogonal polarization states is delivered to two separate spatial light modulators. The polarized light from both modulators is then projected simultaneously. The viewer wears polarized glasses with polarization transmission axes for left and right eyes orthogonally oriented with respect to each other. Although this arrangement offers efficient use of light, it can be a very expensive configuration, especially in color projector designs where a spatial light modulator is required for each color band.

In another approach, a single projector is adapted to provide alternating polarization states that are rapidly switched from one to the other. This can be done, for example, using an achromatic polarization switcher, similar to the type described in U.S. Patent Publication No 2006/0291053 by Robinson et al. A switcher of this type alternately rotates polarized light between two orthogonal polarization states, such as linear polarization states, to allow the alternating presentation of two distinct images, one to each eye, while the user wears polarized glasses.

The goal of providing sufficient brightness for digital cinema applications at an acceptable system cost has been a difficult problem for the designers of digital projection systems. LCD-based systems have been compromised by the requirement for polarized light, reducing efficiency and increasing etendue, even where polarization recovery techniques are used. DLP device designs, not requiring polarized light, have proven to be somewhat more efficient, but still require expensive, short lived lamps and costly optical engines, making them too expensive to compete against conventional cinema projection equipment.

In order to compete with conventional high-end film-based projection systems and provide what has been termed electronic or digital cinema, digital projectors must be capable of achieving comparable cinema brightness levels to this earlier equipment. As some idea of scale, the typical theatre requires on the order of 10,000 lumens projected onto screen sizes on the order of 40 feet in diagonal. The range of screens requires anywhere from 5,000 lumens to upwards of 40,000 lumens.

In addition to this demanding brightness requirement, these projectors must also deliver high resolution (2048×1080 pixels) and provide around 2000:1 contrast and a wide color gamut.

Some digital cinema projector designs have proved to be capable of this level of performance. However, high equipment cost and operational costs have been obstacles. Projection apparatus that meet these requirements typically cost in excess of $50,000 each and utilize high wattage Xenon arc lamps that need replacement at intervals between 500-2000 hours, with typical replacement cost often exceeding $1000. The large etendue of the Xenon lamp has considerable impact on cost and complexity, since it necessitates relatively fast optics to collect and project light from these sources.

One drawback common to both DLP and LCOS LCD spatial light modulators (SLM) has been their limited ability to use solid-state light sources, particularly laser sources. Although they are advantaged over other types of light sources with regard to relative spectral purity and potentially high brightness levels, solid-state light sources require different approaches in order to use these advantages effectively. Conventional methods and devices for conditioning, redirecting, and combining light from color sources, used with earlier digital projector designs, can constrain how well laser array light sources are used.

Solid-state lasers promise improvements in etendue, longevity, and overall spectral and brightness stability but, until recently, have not been able to deliver visible light at sufficient levels and at costs acceptable for digital cinema. In a more recent development, VCSEL (Vertical Cavity Surface-Emitting Laser) laser arrays have been commercialized and show some promise as potential light sources. However, brightness itself is not yet high enough; the combined light from as many as 9 individual arrays is needed in order to provide the necessary brightness for each color.

There are other difficulties with conventional approaches using solid-state arrays for digital projectors. A monolithic array of coherent lasers could be used, for example, such as the microlaser array described in U.S. Pat. No. 5,704,700 entitled “Laser Illuminated Image Projection System and Method of Using Same” to Kappel et al. With this type of approach, the number of lasers is selected to match the power requirements of the lumen output of the projector. In a high lumen projector, however, this approach presents a number of difficulties. Manufacturing yields drop as the number of devices increases and heat problems can be significant with larger scale arrays.

Coherence can also create problems for monolithic designs. Coherence of the laser sources typically causes artifacts such as optical interference and speckle. It is, therefore, preferable to use an array of lasers where coherence, spatial and temporal coherence is weak or negligible. While spectral coherence is desirable from the standpoint of improved color gamut, a small amount of spectral broadening is also desirable for reducing sensitivity to interference and speckle and also lessens the effects of color shift of a single spectral source. This shift could occur, for example, in a three-color projection system that has separate red, green and blue laser sources. If all lasers in the single color arrays are connected together and of a narrow wavelength, and a shift occurs in the operating wavelength, the white point and color of the entire projector may fall out of specification. On the other hand, where the array is averaged with small variations in the wavelengths, the sensitivity to single color shifts in the overall output is greatly reduced. While components may be added to the system to help mitigate coherence, most means of reducing coherence beyond the source utilize components such as diffusers that increase the effective extent of the source (etendue). This can cause additional light loss and add expense to the system. Maintaining the small etendue of the lasers enables a simplification of the optical train for illumination, which is highly desirable.

Laser arrays of particular interest for projection applications are various types of VCSEL arrays, including VECSEL (Vertical Extended Cavity Surface-Emitting Laser) and NECSEL (Novalux Extended Cavity Surface-Emitting Laser) devices from NECSEL Inc., Sunnyvale, Calif. However, conventional solutions using these devices have been prone to a number of problems. One limitation relates to device yields. Due largely to heat and packaging problems for critical components, the commercialized VECSEL array is extended in length, but limited in height; typically, a VECSEL array has only two rows of emitting components. The use of more than two rows tends to dramatically increase yield difficulties. This practical limitation would make it difficult to provide a VECSEL illumination system for projection apparatus. In addition to these problems, conventional VECSEL designs are prone to difficulties with power connection and heat sinking. These lasers are of high power; for example, a single row laser device, frequency doubled into a two row device from NECSEL, produces over 3 W of usable light. Thus, there can be significant current requirements and heat load from the unused current. Lifetime and beam quality is highly dependent upon stable temperature maintenance.

Coupling of the laser sources to the projection system presents another difficulty that is not adequately addressed using conventional approaches. For example, using NECSEL lasers, approximately nine 2 row by 24 laser arrays are required for each color in order to approximate the 10,000 lumen requirement of most theatres. It is desirable to separate these sources, as well as the electronic delivery and connection and the associated heat from the main thermally sensitive optical system to allow optimal performance of the projection engine. Other laser sources are possible, such as conventional edge emitting laser diodes. However, these are more difficult to package in array form and traditionally have a shorter lifetime at higher brightness levels.

In order to provide acceptable stereoscopic images using different polarization states for left- and right-eye images, the polarization states need to be maintained and the corresponding polarization transmission axes for these images must be orthogonal, or substantially orthogonal, at no more than about ±15 degrees from orthogonal. Otherwise, image contrast suffers and there can be excessive crosstalk between left- and right-image channels. Many of the optical components used in digital projection systems are known to introduce some degree of depolarization or polarization rotation. It is therefore difficult to design a digital stereoscopic projection system with a low level of cross-talk, while simultaneously satisfying all of the different image quality and cost constraints that are typically required to produce a commercially acceptable system.

There remains a need for improved designs for digital cinema projection systems that capitalize on the advantages of polarized laser light sources for the formation of stereoscopic images.

### SUMMARY OF THE INVENTION

The present invention provides a digital projection apparatus for projecting digital image data comprising:

one or more image forming assemblies, each image forming assembly including:
a light source that alternately provides polarized light having a first polarization axis and light having a second polarization axis that is substantially orthogonal to the first polarization axis;
an integrator bar having an input face, an exit face and four side surfaces defining a substantially rectangular cross section, wherein the polarization state of light traversing the integrator bar from the input face to the exit face is substantially preserved when the polarization axis of the light is substantially parallel to an opposing pair of side surfaces;
illumination optics that direct the light from the light source onto the input face of the integrator bar such that the first and second polarization axes are substantially parallel to the side surfaces of the integrator bar;
a spatial light modulator having a rectangular shape defined by four edges, the spatial light modulator including an array of tiltable micro-mirror reflectors, each micro-mirror reflector being actuable to tilt with respect to a tilt axis responsive to the digital image data; and
imaging optics for forming an image of the exit face of the integrator bar onto the spatial light modulator, wherein the imaging optics substantially maintain the polarization of the light from the integrator bar such that the polarization axes of the light incident on the spatial light modulator are substantially parallel to the edges of the spatial light modulator;

a display surface; and

projection optics for projecting an image of the spatial light modulators in the one or more image forming assemblies onto the display surface.

It is a feature of the present invention that it provides illumination having reduced cross-talk between the left and right eye images for stereoscopic projection by reducing the total degree of light depolarization.

It is an advantage of the present invention that it simplifies the design and reduces the cost of the stereoscopic projection apparatus by eliminating the need for a polarization rotator in each of the light modulating assemblies.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a schematic block diagram showing a general arrangement of a digital projection apparatus;

FIGS. 2A and 2B are schematic diagrams showing one embodiment of a light source using a polarization beamsplitter that combines light from multiple solid-state light arrays to alternately provide light beams having orthogonal polarization axes along a common illumination path;

FIG. 3 is a timing diagram that shows the alternating timing of polarization states used for stereo image presentation;

FIGS. 4 and 5 are schematic diagrams showing alternate embodiments of a light source incorporating light redirecting prisms;

FIG. 6 is a perspective view showing a single pixel modulator and its axis of rotation;

FIGS. 7A and 7B are schematic diagrams that show an image forming assembly configuration that uses a half wave plate polarization rotator to condition the polarized light incident on the spatial light modulator so as to be more favorable for preserving polarization;

FIG. 8 is a schematic diagram of a stereo projection apparatus using alternating orthogonal polarization states provided by the illumination system described in FIGS. 7A and 7B;

FIGS. 9A and 9B are schematic diagrams that show an image forming assembly configuration according to an embodiment of the present invention which does not use a half wave plate polarization rotator to condition the polarized light incident on the spatial light modulator; and

FIG. 10 is a schematic diagram of a stereo projection apparatus using alternating orthogonal polarization states provided by the illumination system described in FIGS. 9A and 913.

It is to be understood that the attached drawings are for purposes of illustrating the concepts of the invention and may not be to scale.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

Figures shown and described herein are provided to illustrate principles of operation according to the present invention and are not drawn with intent to show actual size or scale. Because of the relative dimensions of the component parts for the laser array of the present invention, some exaggeration is necessary in order to emphasize basic structure, shape, and principles of operation.

This invention may be utilized with Micro-Electromechanical Structures (MEMS) base modulators because they do not vary the polarization of the incoming light on an individual pixel basis. MEMS devices include micro-mirror structures such as the Texas Instruments DLP, Grating Light Valve (GLV) and similar devices such as the Kodak GEMs, and light shutter devices such as the Unipixel Opcuity device.

Embodiments of the present invention address the need for improved brightness in a stereoscopic viewing system using independently addressed polarized laser light sources and provide solutions that can also allow ease of removal and modular replacement of laser assemblies. Embodiments of the present invention additionally provide features that reduce thermal effects that might otherwise cause thermally induced stress birefringence in optical components that are used with polarization based projectors. Embodiments of the present invention take advantage of the inherent polarization of light that is emitted from a VECSEL laser array or other type of solid-state light array.

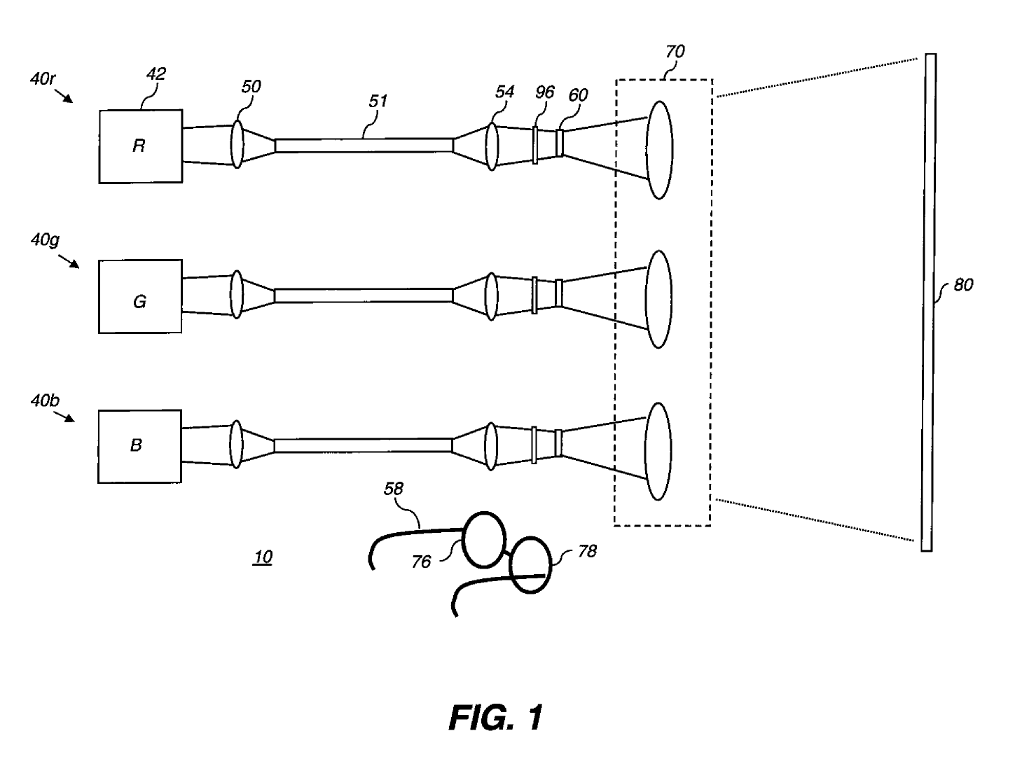

In order to better understand the present invention, it is instructive to describe the overall context within which apparatus and methods of the present invention can be operable. The schematic diagram of FIG. 1 shows a basic arrangement for a projection apparatus 10 that is used in a number of embodiments of the present invention. Three image forming assemblies 40r, 40g, and 40b are shown, each modulating light corresponding to one of the primary Red, Green, or Blue (RGB) colors from a light source 42. In a preferred embodiment of the present invention, the light source 42 alternately provides polarized light having a first polarization axis and light having a second polarization axis that is orthogonal to the first polarization axis. In some embodiments of the present invention, the light source includes an illumination combiner which combines light from a plurality of individual light sources such as VECSEL laser arrays or other types of solid-state light arrays.

In each image forming assembly 40r, 40g, and 40b, illumination optics 50 direct light from the light source 42 into an integrator bar 51. In a preferred embodiment of the present invention, the integrator bar 51 is a rectangular solid having an input face, an exit face and four side surfaces defining a substantially rectangular cross section. The integrator bar 51 has the property that the polarization state of light traversing the integrator bar from the input face to the exit face is substantially preserved when the polarization axis is substantially parallel to a pair of opposing side surfaces of the integrator bar 51. The illumination optics 50 can include components such as lenses or mirrors, or combinations thereof.

In the context of the present disclosure, a structure is substantially rectangular in cross section when it has adjacent sides substantially at right angles to each other to within ±15 degrees, and opposite sides substantially parallel to each other to within ±15 degrees.

At the output of integrator bar, imaging optics 54 direct light from the exit face of the integrator bar 51 onto a spatial light modulator 60. The imaging optics 54 can include components such as lenses or mirrors, or combinations thereof. In some embodiments, the imaging optics 54 form an image of the exit face of the integrator bar 51 onto the spatial light modulator 60. Generally, it will be desirable to arrange the imaging optics 54 in order to overfill the spatial light modulator 60 with the image of the exit face of the integrator bar 51.

In a preferred embodiment, the spatial light modulator 60 is a DLP or other MEMS spatial light modulator component which includes an array of tiltable micro-mirror reflectors. The individual micro-mirrors are actuable to tilt with respect to a tilt axis to switch between an off state and an on state, and are actuated in accordance with input digital image data in order to provide a modulated image. For the case where the projection apparatus 10 is a digital motion picture projector, the digital image data comprises a time sequence of image frames that are projected sequentially to produce a digital motion picture.

In the configuration of the present invention, the spatial light modulator 60 is adapted to accept incident light of two orthogonal input polarization states and should substantially preserve this polarization difference, providing as output modulated light of two orthogonal polarization states that correspond to the respective input states. The output polarization states may, however, be rotated with respect to the input states. In some configurations, an optional polarization rotator 96 is inserted in the optical path between the integrator bar 51 and the spatial light modulator 60 to rotate the polarization axis by a fixed amount. For example, the polarization rotator 96 can be a half-wave plate which can be used to rotate the polarization by 45 degrees.

Support for two orthogonal input polarization states supports that case where the digital projection apparatus is adapted to project stereoscopic digital image data including left eye digital image data and right eye digital image data. In this configuration, the polarization axis of the light provided by the light source is synchronized with the stereoscopic digital image data such that the left eye digital image data is used to drive the spatial light modulator 60 when the light source 42 provides light having the first polarization axis and the right eye digital image data is used to drive the spatial light modulator 60 when the light source 42 provides light having the second polarization axis.

Projection optics 70, indicated generally in a dashed outline in FIG. 1 due to many possible embodiments, then direct the modulated light to a display surface 80. The display surface 80 should be designed to substantially preserve the polarization of the incident light in order to avoid introducing cross-talk between the orthogonal polarization states. Polarization-preserving display surfaces are well known to those in the art.

Polarized glasses 58, worn by a viewer, have polarizer lenses 76 and 78 having orthogonal polarization axes such that the left- and right-eye images are transmitted to the corresponding eye while blocking light of the opposite polarization.

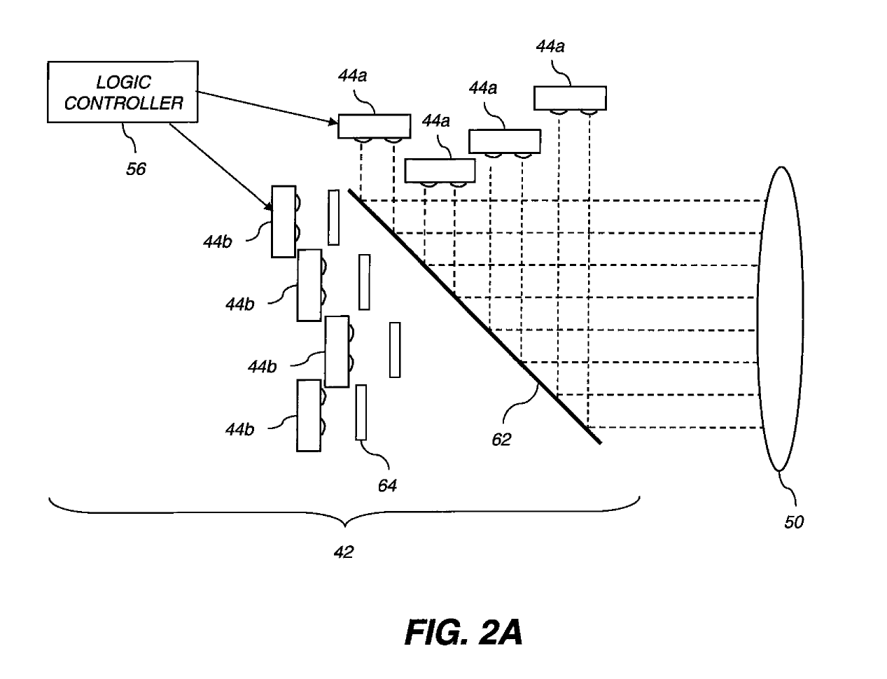

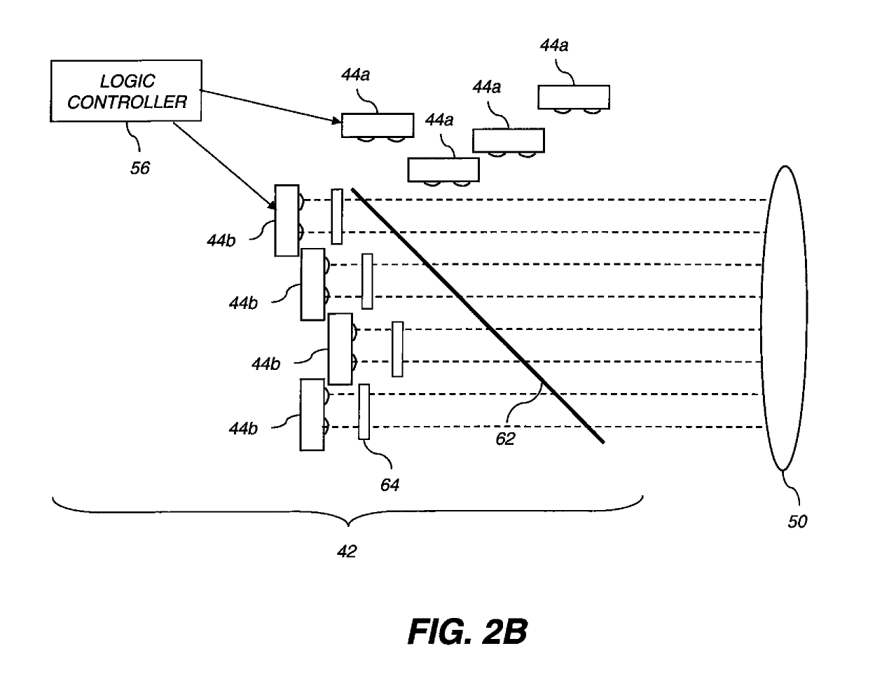

FIGS. 2A and 2B illustrate one configuration for a light source 42 according to one embodiment of the present invention. In this arrangement, multiple solid state light arrays 44a and 44b are combined to form larger arrays. In a preferred embodiment of the present invention, the solid state light arrays 44a and 44b are arrays of solid state laser light sources, such as VECSEL laser arrays.

The solid state light arrays 44a produce light beams having a first polarization state characterized by a first polarization axis, which are reflected from a polarization beamsplitter 62 toward the illumination optics 50.

The polarization state of the light beams produced by the solid state light arrays 44b is modified by polarization rotators 64 to produce light beams having a second polarization state characterized by a second polarization axis that is substantially orthogonal to the first polarization axis. In a preferred embodiment, the polarization rotators 64 are half-wave plates. These light beams are transmitted through polarization beamsplitter 62 toward the illumination optics 50. This arrangement advantageously puts light of either polarization on the same illumination axis, therefore maintaining the etendue of the system.

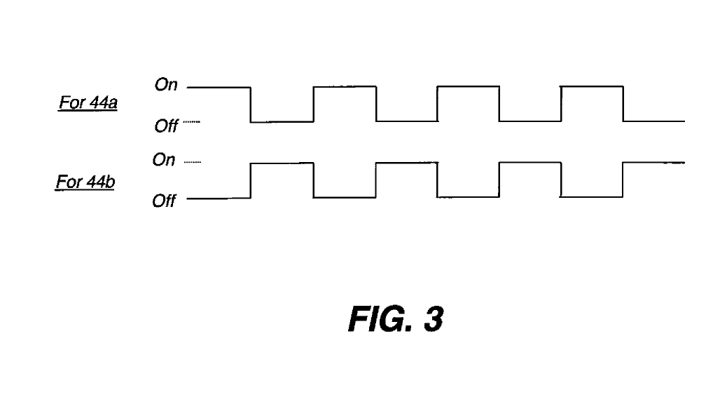

A logic controller 56 is used to alternately energize the solid state light arrays 44a and 44b in order to alternately provide polarized light having the first and second polarization states. In FIG. 2A, the solid state light arrays 44a are shown as being activated to provide polarized light having the first polarization state. In FIG. 2B, the solid state light arrays 44b are shown as being activated to provide polarized light having the second polarization state. The timing diagram of FIG. 3 shows how signals can be generated by the logic controller 56 in order to rapidly alternate between the first and second polarization states to provide light to for the left- and right-eye images accordingly. During one half of the alternating illumination cycle, solid state light arrays 44a are energized, as shown in FIG. 2A. In the other half of the alternating illumination cycle, solid state light arrays 44b are energized, as shown in FIG. 2B. For non-stereoscopic applications, the light from both solid state light arrays 44a and 44b can be provided simultaneously to provide a brighter imager, or used at half power to balance the lifetime of each laser source.

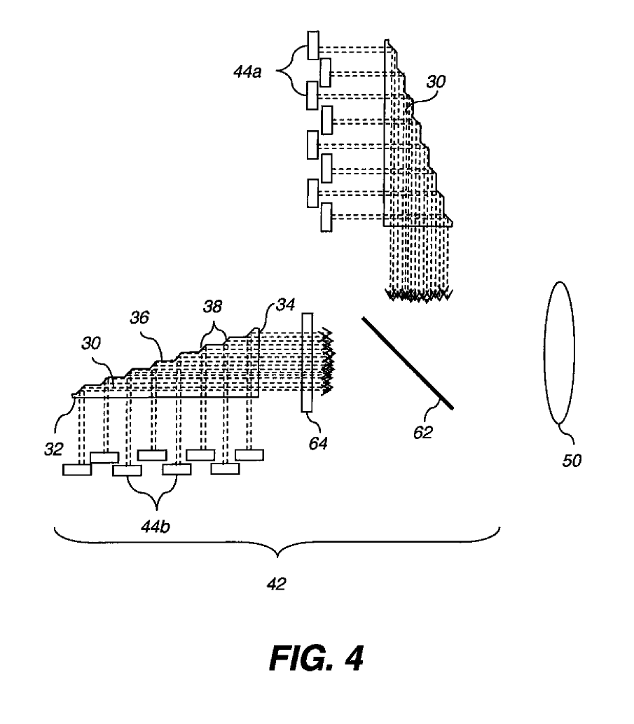

The schematic block diagram of FIG. 4 shows an alternate embodiment of a light source 42 which uses light redirecting prisms 30 to combine the light beams from the solid state light arrays 44a and 44b. The light-redirecting prisms 30 have an incident face 32 that accepts light emitted from the solid state light arrays 44a and 44b, and a redirection surface 36 with redirecting facets 38, which redirect the light out of an output face 34 an output direction that is substantially orthogonal to emission direction. The redirecting facets 38 are at an oblique angle relative to emission direction and provide total internal reflection to light emitted from the solid state light arrays 44a and 44b. When the redirecting facets 38 are staggered as shown, these features help to narrow the light path for this illumination, providing a narrower light beam.

Polarization rotator 64 is used to change the polarization state of the light from the solid state light arrays 44b. As was described earlier with reference to FIGS. 2A and 2B, alternating illumination from the solid state light arrays 44a and 44b, through polarization beamsplitter 62, directs light of orthogonal polarization states toward illumination optics 50 for providing a stereoscopic image.

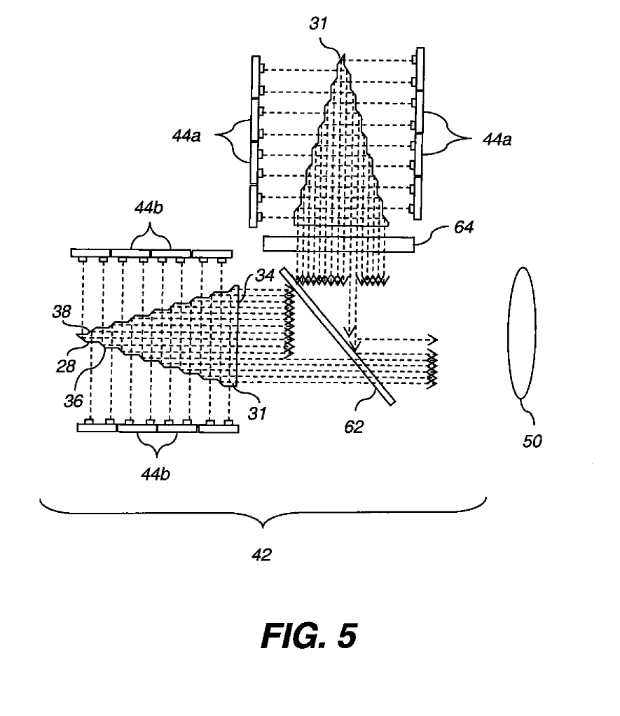

The schematic block diagram of FIG. 5 shows another alternate embodiment of a light source 42 which uses a different form of light redirecting prisms 31 to combine the light beams from the solid state light arrays 44a and 44b. These light-redirecting prisms 31 provides an even more compact arrangement of illumination than the embodiment shown in FIG. 4. In this embodiment, the light redirecting prisms 31 have two redirection surfaces 36, accepting light from solid state light arrays 44a and 44b that are facing each other, with opposing emission directions. Each redirection surface 36 has two types of facets: incidence facets 28 that are normal to the incident light from the corresponding solid state light arrays 44a and 44b, and redirecting facets 38 that redirect the light through output face 34 by total internal reflection. This allows for easier alignment of the various laser modules to the light-redirecting prisms 31 by retro-reflection of a small residual light from an anti-reflection coated face back into each of the lasers. This retro-reflection can be useful as a means of creating a subtle external cavity that may induce mode instability in laser. While such mode hopping may be considered noise under typical applications, this noise can add value in projection by further reducing the laser coherence (and inter-laser coherence), thereby reducing visual speckle at the image plane. Additionally, with this dual sided approach, laser modules are interleaved with light from differing modules neighboring each other, providing a source of further spatial mixing when the light is optically integrated further in the optical system. This again helps to reduce possible speckle and increase system uniformity.

FIGS. 2, 4 and 5 represent only a few examples of configurations that can be used to provide the light source 42 that alternately provides polarized light having first and second polarization axes. Many other configurations can be used for the light source 42 in accordance with the present invention. For example, U.S. patent application Ser. No. 12/502,426, which is incorporated herein by reference, discloses a number of different configurations that make use of a rotating segmented disk to provide the alternating polarization states.

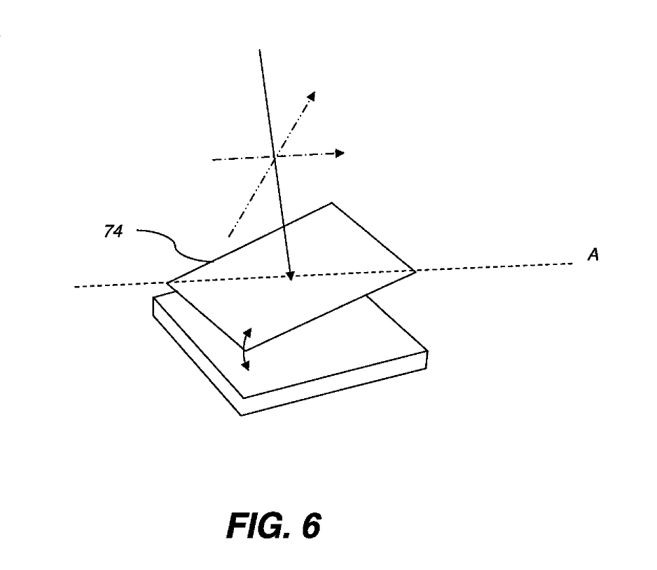

Returning to a discussion of FIG. 1, the light from the light source 42 is modulated using the spatial light modulator 60. As was discussed earlier, in a preferred embodiment, the spatial light modulator is a DLP or other MEMS spatial light modulator component which includes an array of tiltable micro-mirror reflectors. Commonly, such devices incorporate an array of tiltable metallic micro-mirrors, typically formed from aluminum. FIG. 6 is a diagram showing one micro-mirror 74. The micro-mirror 74 can be actuated to tilt with respect to a hinge tilt axis A, thus deflecting the incident light. When the micro-mirror is tilted in a first direction, the incident light is reflected in a direction such that the projection optics 70 (FIG. 1) will project the reflected light onto the display surface 80 (FIG. 1). When the micro-mirror 74 is tilted in a second direction, the reflected light is not projected onto the display surface 80. In this case, the reflected light is generally directed into some form of light dump structure.

Commonly, the tilt axis A will be oriented such that it is not substantially parallel to any of the edges of the spatial light modulator 60. For many common DLP spatial light modulators, such as the Texas Instruments 0.98″ 720 pixel DLP, the tilt axis A is oriented at 45 degrees relative to the edges of the spatial light modulator,

Ideally, the spatial light modulator 60 (FIG. 1) will preserve the polarization state of the incident light. However, it is known that metallic mirrors will introduce some degree of depolarization as a function of the angle of incidence and the polarization angle. Therefore, DLP spatial light modulators, which use metallic micro-mirrors, can partially depolarize the light. The result of this is that light which was intended for one eye will be visible to the other eye, thus creating a ghost image phenomenon. As has been discussed in U.S. Patent Application Publication 2009/0141242, which is incorporated herein by reference, the preferred polarization orientation where the DLP device maintains the polarization state after reflection, has the polarization axis either in line with or orthogonal to the tilt axis A of the micro-mirror 74.

Table 1 shows the results of measurements made with a Texas Instruments 0.98″ 720 pixel DLP spatial light modulator to characterize depolarization as a function of the polarization angle for an angle of incidence of 10 degrees.

TABLE 1
DLP Depolarization

| Polarization Angle | % Depolarization |
|---|---|
| 0° | 0.0059% |
| 45° | 0.032% |

It can be seen that the amount of depolarization is much smaller for a 45 degree polarization angle than for a 0 degree polarization angle, where the angles in this case are angles relative to the edge of the spatial light modulator.

The tilt axis A for the 0.98″ 720 pixel DLP is 45 degrees relative to the edges of the spatial light modulator, therefore it can be seen that the amount of depolarization is substantially lower when the polarization angle of the light incident on the DLP is parallel to the tilt axis A. Similarly, a low degree of depolarization is also observed for polarization angles that are perpendicular to the tilt axis A.

As described in U.S. patent application Ser. No. 12/259,326 to Silverstein et al., entitled “Polarization Maintaining Optical Integration,” it is desirable to orient the integrator bar 51 (FIG. 1) so that its side surfaces are either parallel to (or orthogonal to) the polarization axes in order to minimize depolarization of the light by the integrator bar 51. According to this design, the polarization axis of the light leaving the integrator bar 51 will therefore be substantially parallel to the side surfaces of the integrator bar.

In order to properly fill the spatial light modulator 60 (FIG. 1) with the light from the rectangular exit face of the integrator bar 51 (FIG. 1), it is generally desirable to align the orientation of the spatial light modulator 60 with integrator bar 51 such that their sides are substantially parallel. As a result, the polarization of the light from the integrator bar will be substantially parallel to the edges of the spatial light modulator.

For efficiency of light use, the aspect ratio of the rectangular cross-section of the integrator bar 51 should ideally be matched to the aspect ratio of the spatial light modulator 60. Since the light is normally directed onto the spatial light modulator 60 at a small angle, the matching of the aspect ratios should properly take into account the projection angle. In practice, good performance can be achieved if the aspect ratios are matched to within about 10 percent

In order to minimize the amount of depolarization introduced by the spatial light modulator 60, Silverstein et al. have proposed that a polarization rotator 96 (FIG. 1) is required to properly orient the polarization axis of the light incident on the spatial light modulator 60 (see U.S. Patent Application Publication 2009/0141242). In particular, Silverstein et al. disclosed using a half wave plate polarization rotator 96 to rotate the polarization angle by 45 degrees, as was shown in FIG. 1.

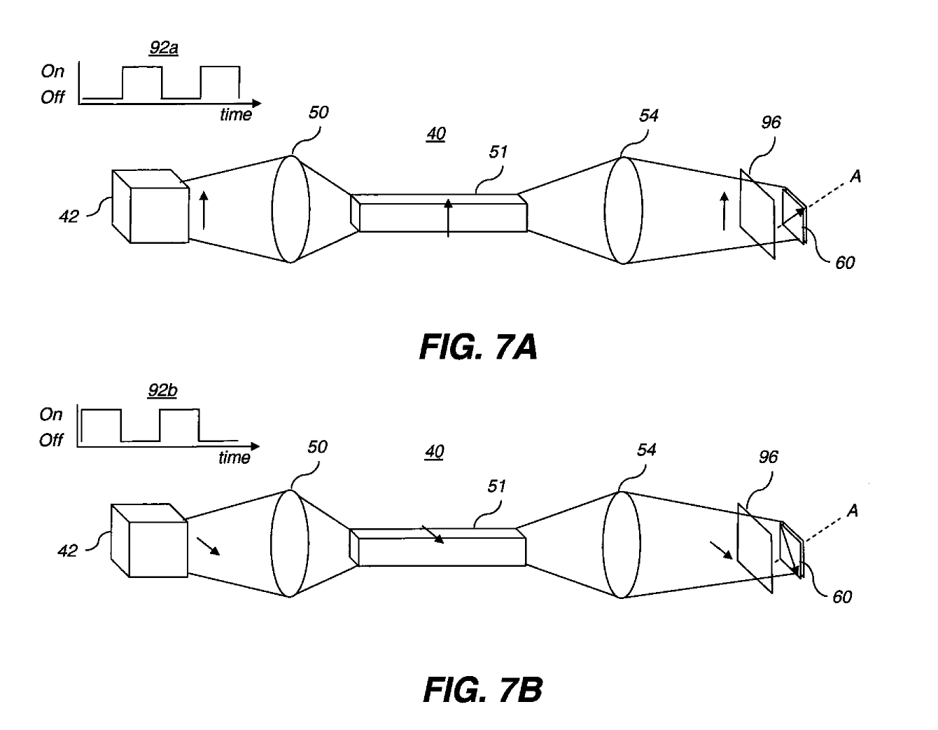

FIGS. 7A and 7B are diagrams showing the polarization directions at various points throughout the image forming assembly 40 of FIG. 1. In this configuration, the polarization axis of the light incident on the spatial light modulator 60 is arranged to be either parallel or perpendicular to the tilt axis A in order to minimize the amount of depolarization introduced by the reflection of the light by the micro-mirrors.

In particular, FIG. 7A shows the case where the light source 42 is providing light having a first polarization axis aligned in a vertical orientation, corresponding to the time intervals when the waveform 92a is in the “on” position. The polarization direction is shown by the arrow symbols. It can be seen that the polarization axis is preserved in the vertical direction through the illumination optics 50, the integrator bar 51 and the imaging optics 54. The polarization angle is then rotated by 45 degrees by the polarization rotator 96 so that the polarization axis is parallel to the tilt axis A of the spatial light modulator 60. Similarly, FIG. 7B shows the case where the light source 42 is providing light having a first polarization axis aligned in a horizontal orientation, corresponding to the time intervals when the waveform 92b is in the “on” position. It can be seen that the polarization axis is preserved in the horizontal through the illumination optics 50, the integrator bar 51 and the imaging optics 54. The polarization angle is then rotated by 45 degrees by the polarization rotator 96 so that the polarization axis is perpendicular to the tilt axis A of the spatial light modulator 60.

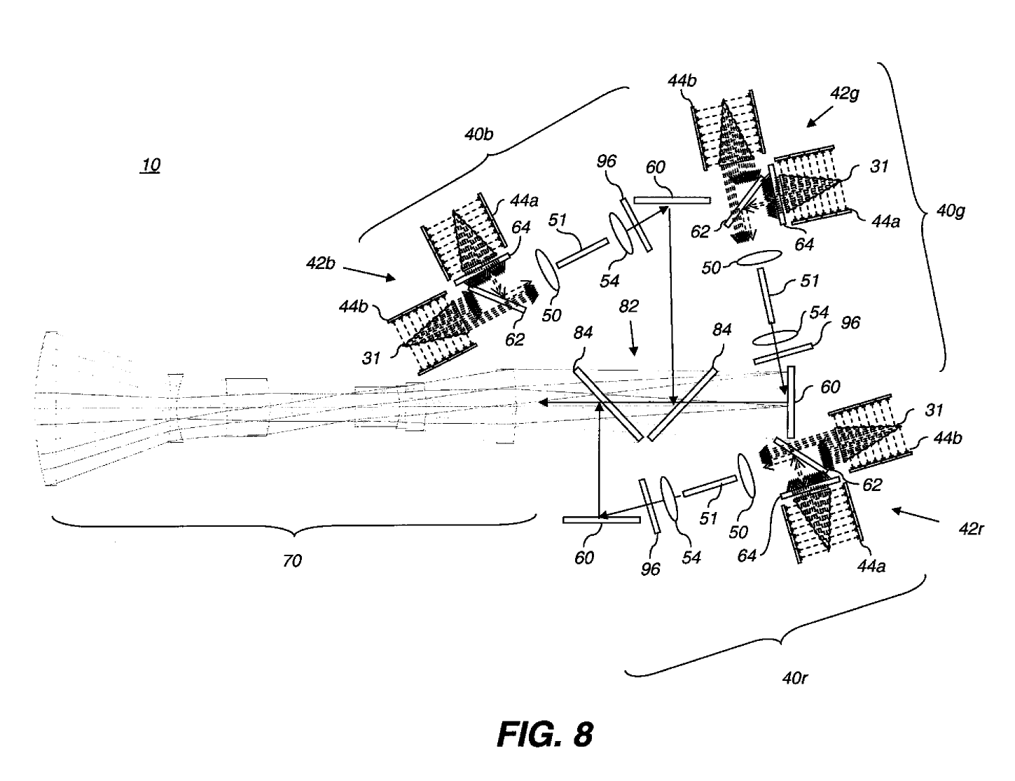

The schematic block diagram of FIG. 8 shows an embodiment of the projection apparatus 10 adapted to project color images having red, green and blue color channels. The projection apparatus includes three image forming assemblies 40r, 40g and 40b, one for each color channel. The image forming assemblies 40r, 40g and 40b include light sources 42r, 42g and 42b that are of the type shown in FIG. 5. The light sources 42r, 42g and 42b produce light having a red, green and blue color, respectively. Each light source 42r, 42g and 42b includes solid-state light arrays 44a and 44b, a pair of light redirecting prisms 31, a polarization beamsplitter 62 and a polarization rotator 64. Each of the image forming assemblies 40r, 40g and 40b also includes illumination optics 50, an integrator bar 51, imaging optics 54, polarization rotator 96, and a spatial light modulator 60. Modulated light from the spatial light modulators 60 is directed to a dichroic combiner 82. The dichroic combiner 82 has an arrangement of dichroic surfaces 84 that selectively reflect or transmit light according to wavelength, combining the modulated light from each image forming assembly 40r, 40g, and 40b onto a single optical path through projection optics 70.

The configuration described with respect to FIGS. 7A, 7B and 8 has the advantage that it minimizes the depolarization introduced by the spatial light modulators 60. However, a number of practical considerations have been found to impact the effectiveness of this advantage. In particular, the inclusion of the polarization rotator 96 has been found to limit the system performance. In a preferred embodiment, the polarization rotator 96 is a half-wave plate.

A variety of different types of half-wave plates are commercially available. Some half-wave plates are made using quartz. Quartz half-wave plates have the advantage that they can introduce very low levels of depolarization, typically less than 0.005% when used to rotate the polarization axis by 45 degrees. Zero-order quartz wave plates can be made using two retarders that subtract in retardation to provide a single retardation of less than one wave. These wave plates can be very difficult to fabricate as each retarder has error and the assembly has error. Adhesives used to assemble the wave plates also are sensitive to absorption causing failure at high light levels. Low-order wave plates are easier and cheaper to fabricate, but have a higher temperature and angle sensitivity than true zero-order plates, which reduces their effective polarization performance in practice. However, they too are difficult to manufacture at sizes that would be required for use in the projector apparatus 10, and are therefore quite expensive. Since digital projection systems require high illumination levels, they generate a lot of heat, and the retardance temperature sensitivity can be particularly problematic. The angular sensitivity also places significant design constraints on the F/# of the optical system. As a result, quartz wave plates are not ideal for this application.

Other common types of half-wave plates are fabricated using either polymer materials or UV-cured liquid crystal materials. These types of half-wave plates tend to be less expensive and have better temperature and angle sensitivity characteristics. However, they are generally susceptible to material degradation problems when they are subjected to the high power density levels present in the optical path of the image forming assemblies. They also tend to produce relatively high levels of depolarization, often in the range of 0.1% to 1% as it is very difficult to maintain ideal material properties to deliver perfect retardance.

Therefore, it can be seen that the depolarization advantages gained by rotating the polarization to the optimal angles for the spatial light modulator are negated by the depolarization and other disadvantages introduced by the inclusion of the half-wave plate. In practice, Applicants have discovered experimentally that equal, or even better, depolarization performance can be achieved by removing the polarization rotators 96 from the system configurations shown in FIGS. 7A, 7B and 8, even though the retardance polarization rotation that they provide, in the ideal case, should provide an improvement.

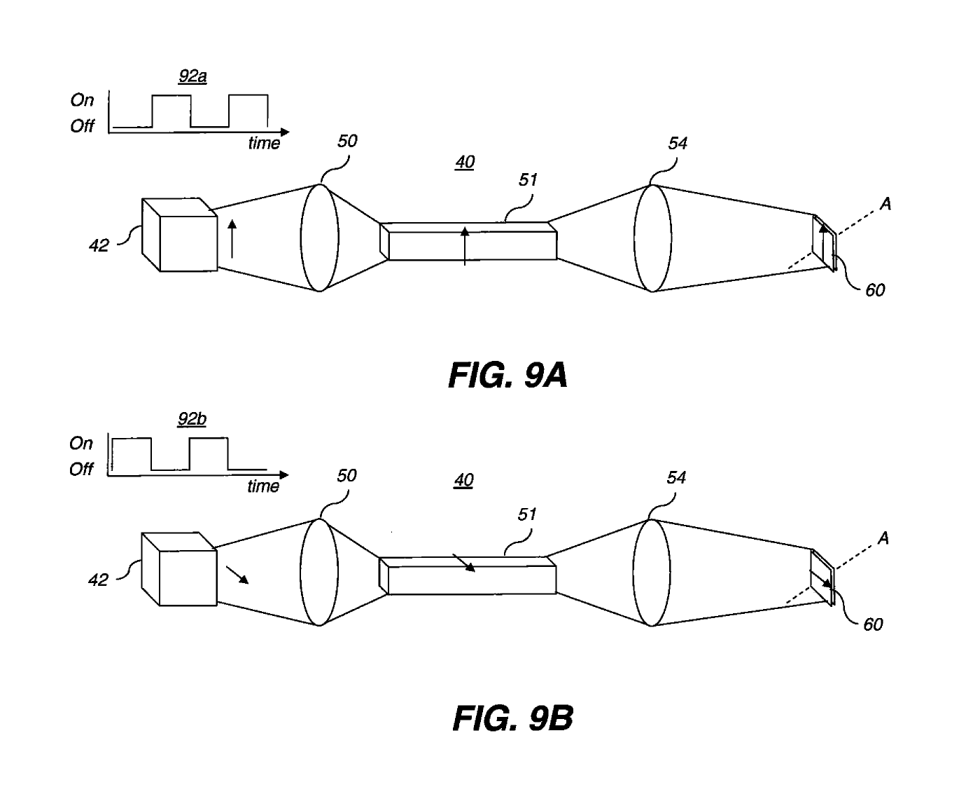

FIGS. 9A and 9B are diagrams showing the polarization directions at various points throughout the image forming assembly 40 for the case where the polarization rotator 96 shown in FIGS. 7A and 7B has been removed. In this configuration, the polarization axis of the light incident on the spatial light modulator 60 is arranged to be substantially parallel to the edges of the spatial light modulator.

In particular, FIG. 9A shows the case where the light source 42 is providing light having a first polarization axis aligned in a vertical orientation, corresponding to the time intervals when the waveform 92a is in the “on” position. It can be seen that the polarization axis is preserved in the vertical direction through the illumination optics 50, the integrator bar 51, the imaging optics 54 and onto the spatial light modulator 60.

Similarly, FIG. 9B shows the case where the light source 42 is providing light having a first polarization axis aligned in a horizontal orientation, corresponding to the time intervals when the waveform 92b is in the “on” position. It can be seen that the polarization axis is preserved in the horizontal through the illumination optics 50, the integrator bar 51, the imaging optics 54, and onto the spatial light modulator 60.

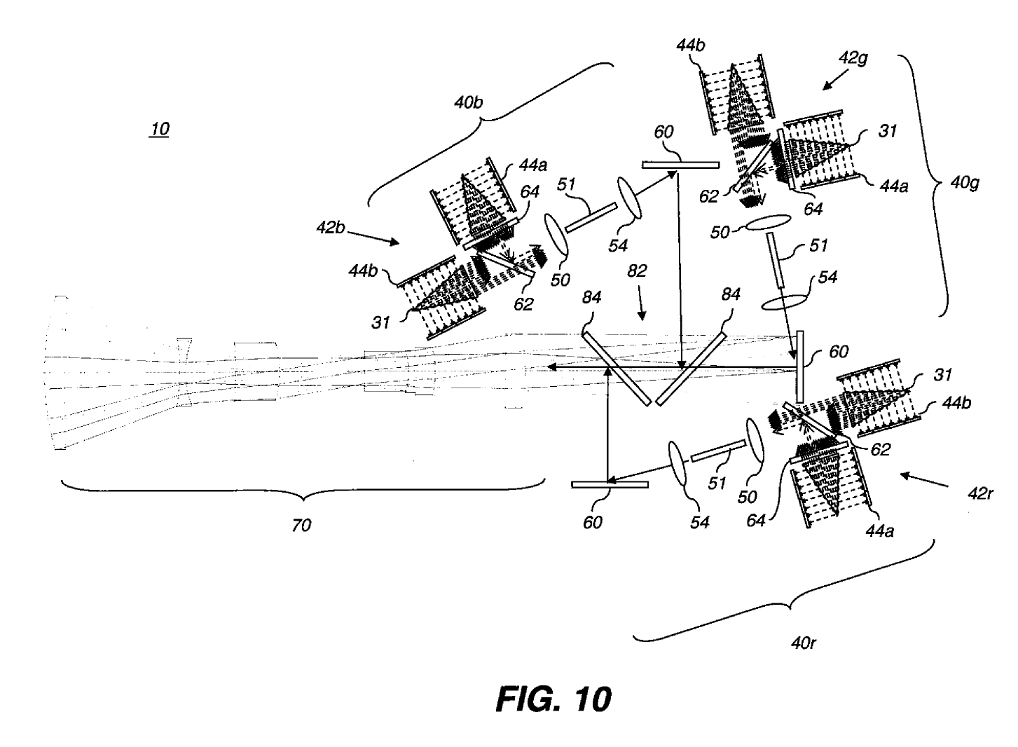

The schematic block diagram of FIG. 10 shows an embodiment of the projection apparatus 10 of FIG. 8 where the polarization rotators 96 have been removed. In this configuration, the amount of depolarization caused by the reflection of the light from the micro-mirrors in the spatial light modulator will correspond to the 45 degree polarization angle in Table 1. Even though the depolarization introduced at the spatial light modulator is higher than in the configuration of FIGS. 7A and 7B, the overall system performance has been found to be higher, and to be acceptable for typical stereoscopic projection applications where the overall crosstalk to the viewer would ideally be less than 2%. In addition, it has the advantage of being lower cost due to the fact that fewer components are required.

In an alternate embodiment, a spatial light modulators 60 can be used in the image forming assemblies 40r, 40g, 40b wherein the tilt axis for the micro-mirror reflectors is oriented substantially parallel to one of the edges of the spatial light modulator. This configuration would have the advantage that the depolarization introduced by the spatial light modulators 60 will be minimized without requiring the use of polarization rotators 96. As a result, the overall amount of depolarization can be reduced relative to either the FIG. 8 or the FIG. 10 configurations where conventional DLP spatial light modulators are used having a 45 degree tilt axis.

The invention has been described in detail with particular reference to certain preferred embodiments thereof, but it will be understood that variations and modifications can be effected within the spirit and scope of the invention. For example, where laser arrays are described in the detailed embodiments, other solid-state emissive components could be used as an alternative. Supporting lenses may also be added to each optical path. In optical assemblies shown herein, the order of the uniformization or light integration and relaying may be reversed without significant difference in effect.

### PARTS LIST

10 Projection apparatus
28 Incidence facet
30 Light redirecting prism
31 Light redirecting prism
32 Incident face
34 Output face
36 Redirection surface
38 Redirecting facet
40 Image forming assembly
40r Image forming assembly
40g Image forming assembly
40b Image forming assembly
42r Light source
42g Light source
42b Light source
44a Solid-state light array
44b Solid-state light array
50 Illumination optics
51 Integrator bar
54 Imaging optics
56 Logic controller
58 Polarized glasses
60 Spatial light modulator
62 Polarization beamsplitter
64 Polarization rotator
70 Projection optics
74 micro-mirror
76 Polarizer lens
78 Polarizer lens
80 Display surface
82 Dichroic combiner
84 Dichroic surface
92a Waveform
92b Waveform
96 Polarization rotator

1. A digital projection apparatus for projecting digital image data comprising:
one or more image forming assemblies, each image forming assembly including:
a light source that alternately provides polarized light having a first polarization axis and light having a second polarization axis that is substantially orthogonal to the first polarization axis;
an integrator bar having an input face, an exit face and four side surfaces defining a substantially rectangular cross section, wherein the polarization state of light traversing the integrator bar from the input face to the exit face is substantially preserved when the polarization axis of the light is substantially parallel to an opposing pair of side surfaces;
illumination optics that direct the light from the light source onto the input face of the integrator bar such that the first and second polarization axes are substantially parallel to the side surfaces of the integrator bar;
a spatial light modulator having a rectangular shape defined by four edges, the spatial light modulator including an array of tiltable micro-mirror reflectors, each micro-mirror reflector being actuable to tilt with respect to a tilt axis responsive to the digital image data; and
imaging optics for forming an image of the exit face of the integrator bar onto the spatial light modulator, wherein the imaging optics substantially maintain the polarization of the light from the integrator bar such that the polarization axes of the light incident on the spatial light modulator are substantially parallel to the edges of the spatial light modulator;
a display surface; and
projection optics for projecting an image of the spatial light modulators in the one or more image forming assemblies onto the display surface.

2. The digital projection apparatus of claim 1 wherein the tilt axis for the micro-mirror reflectors is oriented such that it is not substantially parallel to any of the edges of the spatial light modulator.

3. The digital projection apparatus of claim 2 wherein the tilt axis for the micro-mirror reflectors is oriented at substantially 45 degrees relative to the edges of the spatial light modulator.

4. The digital projection apparatus of claim 1 wherein the tilt axis for the micro-mirror reflectors is oriented substantially parallel to one of the edges of the spatial light modulator.

5. The digital projection apparatus of claim 1 wherein no polarization rotating element is interposed between the spatial light modulator and the integrator bar.

6. The digital projection apparatus of claim 1 wherein the light source includes one or more laser light sources.

7. The digital projection apparatus of claim 1 wherein the digital image data comprises a time sequence of image frames that are projected sequentially to produce a digital motion picture.

8. The digital projection apparatus of claim 1 wherein the digital projection apparatus is adapted to project stereoscopic digital image data including left eye digital image data and right eye digital image data, and wherein the polarization axis of the light provided by the light source is synchronized with the stereoscopic digital image data such that the left eye digital image data is used to drive the spatial light modulator when the light source provides light having the first polarization axis and the right eye digital image data is used to drive the spatial light modulator when the light source provides light having the second polarization axis.

9. The digital projection apparatus of claim 1 wherein the digital projection apparatus is a color projection apparatus adapted to project color digital image data having at least three color channels, and wherein the color projection apparatus includes at least three image forming assemblies having different color light sources.

10. A method for providing illumination for stereoscopic projection comprising:
energizing a light source that alternately provides polarized light having a first polarization axis and light having a second polarization axis that is orthogonal to the first polarization axis;
forming a uniformized light beam by directing the polarized light from the light source onto an integrator bar having an input face, an exit faces and four side surfaces defining a substantially rectangular cross section, wherein the polarization state of light traversing the integrator bar from the input face to the exit face is substantially preserved and wherein the first and second polarization axes are substantially parallel to the side surfaces of the integrator bar; and
directing the uniformized light beam onto a spatial light modulator having a rectangular shape defined by four edges such that the polarization axes of the light incident on the spatial light modulator are substantially parallel to the edges of the spatial light modulator, the spatial light modulator including a array of tiltable micro-mirror reflectors, each micro-mirror reflector being actuable to tilt with respect to a tilt axis responsive to digital image data.
